(19) United States
(12) Patent Application Publication
(10) Pub. No.: US 2017/0268459 A1
(43) Pub. Date: Sep. 21, 2017

(54) LOCKING CLIP FOR FIXING AN ELONGATED OBJECT TO AN INTERNAL COMBUSTION ENGINE

(71) Applicant: GM GLOBAL TECHNOLOGY OPERATIONS LLC, Detroit, MI (US)

(72) Inventors: Rosalino Massimiliano ALLETTO, Torino (IT); Stefano MURATORE, Torino (IT)

(73) Assignee: GM GLOBAL TECHNOLOGY OPERATIONS LLC, Detroit, MI (US)

(21) Appl. No.: 15/461,221

(22) Filed: Mar. 16, 2017

(30) Foreign Application Priority Data
Mar. 17, 2016 (GB) 1604583.3

(51) Int. Cl. F02F 7/00; F16L 3/137; F16L 3/12

(52) U.S. Cl. CPC F02F 7/0068; F16L 3/1211; F16L 3/137

(57) ABSTRACT

A locking clip is disclosed for fixing an elongated object externally with respect to an internal combustion engine. The locking clip includes first and second plates connected by a looping portion. The first plate is inclined with respect to the second plate by an angle of inclination. The first and second plates are provided with through holes. Protuberances extend from the first and second plates into the through holes and are configured to engage with a threaded portion of a threaded fastener extending from the internal combustion engine.

### CROSS-REFERENCE TO RELATED APPLICATION

This application claims priority to GB Patent Application No. 1604583.3, filed Mar. 17, 2016, which is incorporated herein by reference in its entirety.

### TECHNICAL FIELD

The present disclosure pertains to a locking clip for fixing an elongated object to an internal combustion engine.

### BACKGROUND

It is known to clamp an elongated object, such as a tube or a cable, to an external portion of an internal combustion engine using a plastic clip provided with a protruding portion suitable to be inserted into a custom-made boss. The clip includes a seat for the elongated object. Once the protruding portion of the clip is inserted into the boss in the elongated object is clamped to the clip by a retainer, such as a deformable plastic strip.

A disadvantage of this solution is that it needs a dedicated fixation area, leading to an increase in costs and in weight of the engine and, at the same time, it reduces the space available in the engine compartment. Accordingly, there is a need to provide a locking clip for an elongated object such as a tube or a cable that can be fixed to an internal combustion engine without requiring modifications to already existing engine components.

### SUMMARY

An embodiment of the disclosure provides a locking clip for fixing an elongated object externally with respect to an internal combustion engine, the locking clip including a first and second plate connected together by a looping portion. The first plate is inclined with respect to the second plate by an angle of inclination. The first and second plates are provided with through holes. At least one through hole includes a protuberance extending from the associated plate for engaging with a threaded portion of a fastener extending from the internal combustion engine. Preferably, each of the first and second plates includes a plurality of protuberances protruding into the through hole. Thus, an outer perimeter of the through hole is defined by one or more protuberances of the respective plate. The protuberances are co-planar with the plate. The fastener may be a threaded fastener.

An advantage of this embodiment is that the locking clip does not need a specific or custom-made boss to be fixed to the engine because the locking clip can be fixed directly on a free threaded portion of a threaded fastener currently in use. Other advantages of the above embodiment entails a reduced quantity of machining operations by virtue of the fact that a dedicated boss is no longer needed. This embodiment also provides more available space in the engine compartment and has the further benefit of using of a single component instead of two components as required by conventional techniques, namely a plastic strip and plastic clip. The above embodiment is readily replaceable during service operations and enables faster assembly.

According to another embodiment, the looping portion is connected to the first plate by a bent portion. The bent portion may define a concave surface on the outside and a convex surface on the inside, which is the side between the plates. Thus, the bent portion provides a concaved transition between the convexly curved looping portion and the planar first plate. An advantage of this embodiment is that the bent portion obtains the desired an angle of inclination between the first and the second plate.

According to still another embodiment, each of the through holes includes a plurality of notches, each adjacent pair of notches contributing to define one of the protuberances of the respective through hole. An advantage of this embodiment is that such configuration provides the required elasticity to the protuberances in order to firmly lock the locking clip to the threaded portion of the threaded fastener.

According to a further embodiment, the notches and the protuberances of the first through hole are substantially superimposed to the notches and to the protuberances of the second through hole. An advantage of this embodiment is that such configuration creates a space for the insertion of to the threaded portion of the threaded fastener.

According to another embodiment, the angle of inclination between the first and the second plate is included between 10° and 30°. An advantage of these two embodiments is that it optimizes the angle of inclination between the first and the second plate with regards to space constraints inside the engine compartment.

The locking clip may be configured so that it is collapsible from an inclined configuration in which the first and second plates are inclined by the angle of inclination to a superimposed configuration in which the first and second plates are brought together. The locking clip may be elastically biased to the inclined configuration. For example, the clip can be made of spring metal such as spring steel. The through holes may be aligned in the superimposed configuration. That is, a central axis passing through each through hole may coincide with one another in the superimposed configuration. The looping portion may form a closed loop when the clip is in the superimposed configuration. The looping portion is configured for wrapping around the elongated object.

Another embodiment provides for an internal combustion engine assembly including a locking clip as above defined. The protuberances of the first through hole and the protuberances of the second through hole of the locking clip engage on a threaded portion of a fastener, e.g. a screw, bolt or threaded stud, protruding from the internal combustion engine. An advantage of this embodiment is that it allows a self-locking of the locking clip by engaging on the threaded portion of the threaded fastener.

According to another embodiment, the protuberances of the second through hole of the locking clip engage with the threaded portion of the threaded fastener in a position in which the second plate of the locking clip is substantially perpendicular to a longitudinal axis of the threaded fastener. An advantage of this embodiment is that it improves the connection of the locking clip to the threaded fastener.

According to still another embodiment, the protuberances of the first through hole of the locking clip engage with the threaded portion of the threaded fastener in a position in which the first plate of the locking clip is inclined by an angle of inclination with respect to a longitudinal axis of the threaded fastener. An advantage of this embodiment is that the inclination of the first plate with respect to the longitudinal axis of the threaded fastener improves the connection of the locking clip to the threaded fastener by engaging the threaded portion of the threaded fastener at different positions along the length of the threaded portion.

According to still another embodiment, the looping portion of the locking clip holds an elongated object. An advantage of this embodiment is that only one element is needed to hold an elongated object such as a cable or a tube.

The present disclosure further includes an automotive system equipped with an internal combustion engine assembly as above described.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 shows a top view of a locking clip according to an embodiment of the present disclosure;

FIG. 4 shows a sectional view along plane A-A of the locking clip of FIG. 3;

FIG. 5 shows a perspective view of the locking clip of FIGS. 3-4; and

FIG. 6 shows a perspective view of the locking clip of FIGS. 3-5 in an operative position.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

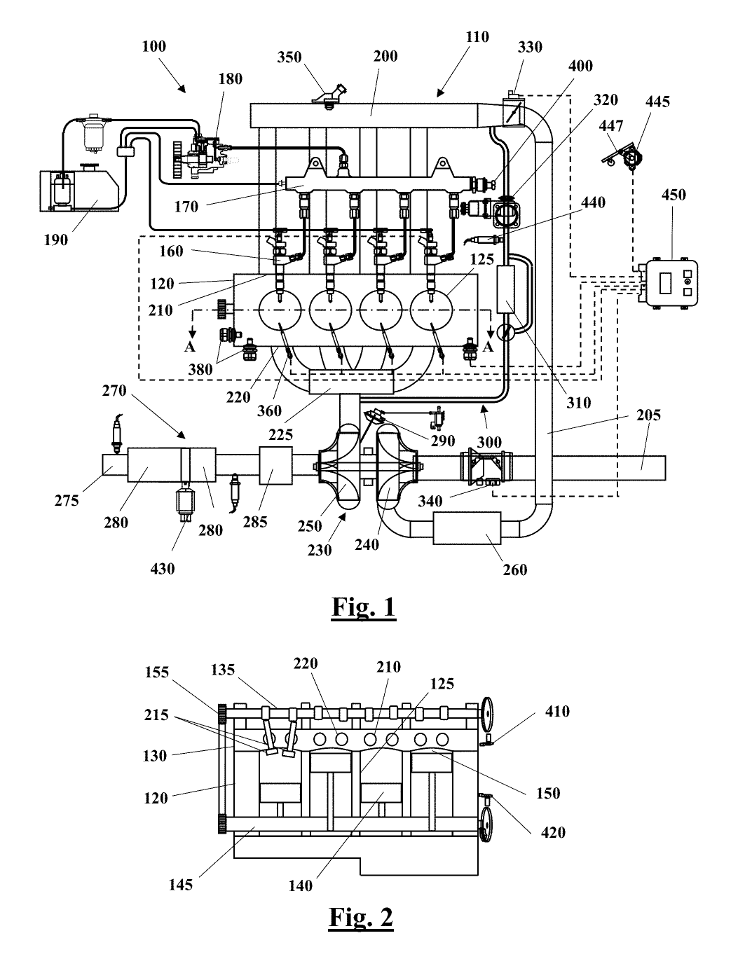

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200.

In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. A charge air cooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move a rack of vanes 295 in different positions, namely from a fully closed position to a fully open position, to alter the flow of the exhaust gases through the turbine 250. In other embodiments, the turbocharger 230 may be fixed geometry and/or include a waste gate.

The exhaust gases of the engine are directed into an exhaust system 270. The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOₓ traps, hydrocarbon adsorbers, selective catalytic reduction (SCR) systems, and particulate filters.

Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110 and with a memory system and an interface bus. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor that may be integral within glow plugs 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal 447 position sensor 445. Furthermore, the ECU 450 may generate output signals to various control devices that are arranged to control the operation of the ICE 110, including, but not limited to, the fuel injectors 160, the throttle body 330, the EGR Valve 320, a Variable Geometry Turbine (VGT) actuator 290, and the cam phaser 155. Note, dashed lines are used to indicate communication between the ECU 450 and the various sensors and devices, but some are omitted for clarity.

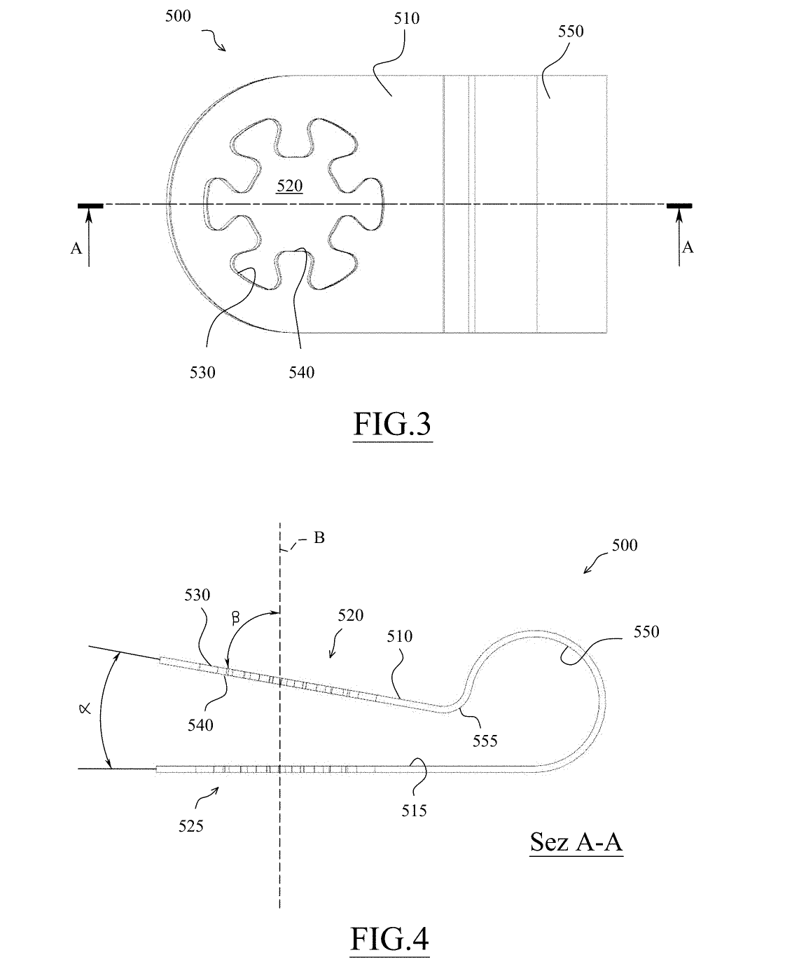

FIG. 3 shows a top view of a locking clip 250 according to an embodiment of the present disclosure. The locking clip 500 is suitable for fixing an elongated object 610, such as a cable or a tube, externally with respect to an internal combustion engine 110. The locking clip 500 includes a first plate 510 and a second plate 515, wherein the first and second plate 510,515 are mutually opposed and are connected together by a looping portion 550. In particular, the looping portion 550 may have a substantially C-shaped configuration. The looping portion 550 is connected to the first plate 510 by bent portion 555.

The first plate 510 is provided with a first through hole 520 and the second plate 515 is provided with a second through hole 525, the through holes 520,525 being mutually opposed. The first through hole 520 is defined by a plurality of notches 530 and protuberances 540 and, the second through hole 525 is also defined by a corresponding plurality of notches 530′ and protuberances 540′. The protuberances 540, 540′ have an inner edge defining a central through hole and the notches 530, 530′ are open to the central through hole at an inner periphery and extend radially outward therefrom. The notches 530, 530′ and the central through hole together define the through holes 520, 525.

In particular, each adjacent pair of notches 530 of the first through hole 520 contributes to define one of the protuberances 540 of the first through hole 520 providing the required elasticity to the protuberances 540. The same applies to the second through hole 525, where each adjacent pair of notches 530′ contributes to define one of the protuberances 540′ of the second through hole 525.

FIG. 4 shows a sectional view along plane A-A of the locking clip 500 of FIG. 3 from which it can be seen that the mutually opposite first and second plate 510,515 are in general not parallel, but the first plate 510 is inclined upwardly with respect to the second plate 515, and is inclined by an angle of inclination a with respect to the second plate 515. The bent portion 555 connecting the looping portion 550 with the first plate 510 contributes to incline upwardly the first plate 510 with respect to the second plate 515. The angle of inclination a between the first and the second plate 510,515 is preferably included between 10° and 30°. In FIG. 4, a longitudinal axis B of a threaded fastener (not represented for simplicity in FIG. 4) is also shown for reference purposes.

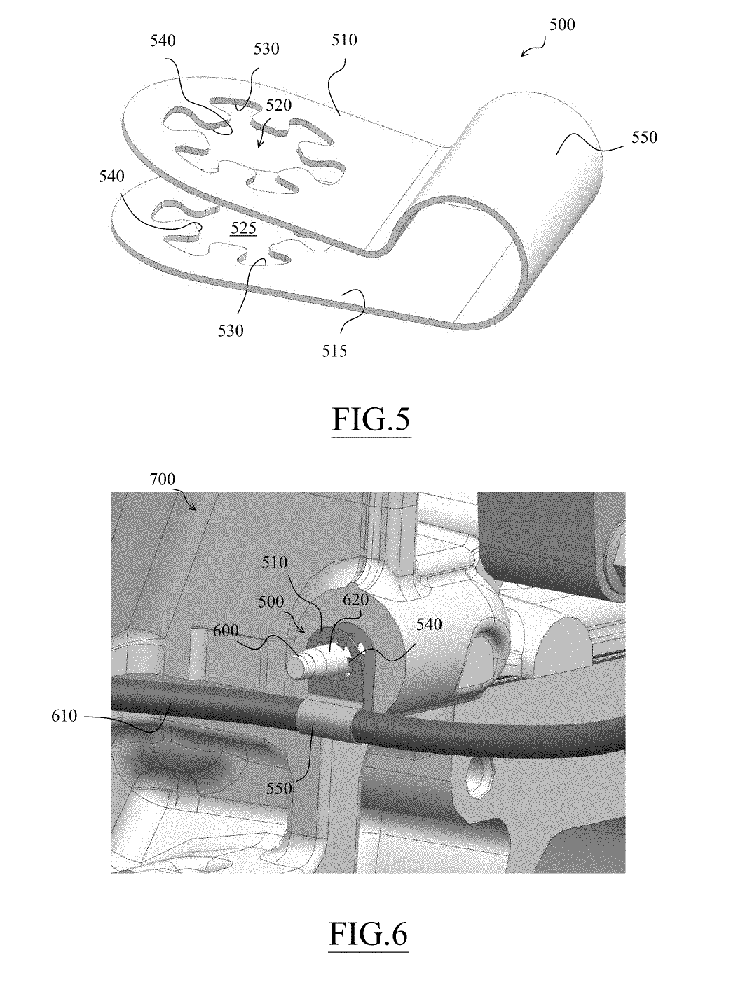

FIG. 5 shows a perspective view of the locking clip 500 of FIGS. 3-4. From FIG. 5 it can be clearly seen that, in the illustrated embodiment, the first through hole 520 is similar to the second through hole 525 and is placed in an opposite portion with respect to the second through hole 525 in such a way that the notches 530 and protuberances 540 of the first through hole 520 are almost superimposed to the notches 530′ and protuberances 540′ of the second through hole 525.

FIG. 6 shows a perspective view of the locking clip 500 of FIGS. 3-5 in an operative position. In such operative position, the locking clip 500 may hold a portion of an elongated object 610, such as a tube or a cable, passing through the looping 550. The locking clip 500 is connected to a threaded portion 620 of a threaded fastener 600 of the internal combustion engine 110, preferably exploiting the last external portion of an already used threaded fastener 600, in case the threaded fastener 600 is engaged into a through hole.

In the alternative, a threaded fastener 600 can be used. The threaded fastener 600 has a length sufficient to provide a threaded portion 620 extending outside the through hole. The second through hole 525 engages with its protuberances 540′ on the threaded portion 620 of the threaded fastener 600 in a position in which the first plate 510 is in a substantially perpendicular fashion with respect of a longitudinal axis B of the threaded fastener 620.

On the contrary the first through hole 520 engages with its protuberances 540 on the threaded portion 620 of the threaded fastener 600 in a position in which the second plate 515 is in a substantially inclined fashion with respect to the longitudinal axis B of the threaded fastener 600, namely the second plate 515 is inclined by an angle of inclination β with respect to the longitudinal axis B of the threaded fastener 600.

Such configuration improves the fixing of the locking clip 500 to the threaded fastener 600 because the protuberances 540 of the first through hole 520 engage thread of the threaded portion 620 of the threaded fastener 600 in different positions along the longitudinal surface of thread.

In order to decouple the locking clip 500 from the threaded fastener 600, the plates 510,515 are temporarily drawn near one to another in a substantially parallel configuration in such a way to disengage the protuberances from the threaded fastener 600. The locking clip 500 is elastic and may be made with a metallic material such as spring steel.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A locking clip for fixing an elongated object externally with respect to an internal combustion engine, the locking clip comprising:
a first plate having a first through hole formed therein;
a second plate having a second through hole formed therein; and
a looping portion interconnecting the first and second plates such that the first plate is inclined with respect to the second plate by an angle of inclination;
wherein at least one of the first and second plates includes a plurality of protuberances extending into an associated through hole and configured to engage with a threaded portion of a fastener extending from the internal combustion engine.

15. The locking clip according to claim 14, wherein each of the first and second plates includes a plurality of protuberances extending into the associated through hole

16. The locking clip according to claim 15, wherein the looping portion comprises a bent portion connected to the first plate.

17. The locking clip according to claim 15, wherein each of the through holes comprises a plurality of notches, each adjacent pair of notches defining a protuberance of the respective through hole.

18. The locking clip according to claim 17, wherein the notches and the protuberances of the first through hole are substantially superimposed to the notches and the protuberances of the second through hole.

19. The locking clip according to claim 15, wherein the angle of inclination between the first and second plates is in a range between 10° and 30°.

20. The locking clip according to claim 14, wherein the locking clip is configured to be collapsible from an inclined configuration in which the first and second plates are inclined by the angle of inclination to a superimposed configuration in which the first and second plates are brought together.

21. The locking clip according to claim 20, which is elastically collapsible and biased to the inclined configuration.

22. The locking clip according to claim 20, wherein the through holes are aligned in the superimposed configuration.

23. An internal combustion engine assembly comprising an engine component, a threaded fastener extending from the engine component and a locking clip according to claim 15, wherein the plurality of protuberances engage on a threaded portion of the threaded fastener.

24. The internal combustion engine assembly according to claim 23, wherein the protuberances of the second through hole engage with the threaded portion of the fastener in a position in which the second plate of the locking clip is substantially perpendicular to a longitudinal axis of the fastener.

25. The internal combustion engine assembly according to claim 23, wherein the protuberances of the first through hole engage with the threaded portion of the fastener in a position in which the first plate is inclined by a second angle of inclination with respect to the longitudinal axis of the fastener.

26. The internal combustion engine assembly according to claim 23, further comprising an elongated object retained in the looping portion of the locking clip.

27. An automotive system comprising:
an internal combustion engine assembly having an engine component and a threaded fastener extending from the engine component;
a locking clip having a first plate with a first through hole formed therein and a plurality of first protuberances extending into the first through hole, a second plate having a second through hole formed therein and a plurality of second protuberances extending into the second through hole, and a looping portion connected to interconnecting the first and second plates such that the first plate is inclined with respect to the second plate by an angle of inclination; and
an elongated object retained in the looping portion of the locking clip;
wherein the first and second protuberances engage with a threaded portion of the fastener extending from the internal combustion engine to secure the locking cli and the elongated object to the engine component.

28. The automotive system according to claim 27, wherein each of the through holes comprises a plurality of notches, each adjacent pair of notches defining a protuberance of the respective through hole.

29. The automotive system according to claim 29, wherein the notches and the protuberances of the first through hole are substantially superimposed to the notches and the protuberances of the second through hole.

30. The automotive system according to claim 27, wherein the angle of inclination between the first and second plates is in a range between 10° and 30°.

31. The automotive system according to claim 27, wherein the locking clip is configured to be collapsible from an inclined configuration in which the first and second plates are inclined by the angle of inclination to a superimposed configuration in which the first and second plates are brought together.

32. The automotive system according to claim 32, which is elastically collapsible and biased to the inclined configuration.

33. The automotive system according to claim 32, wherein the through holes are aligned in the superimposed configuration.
